(19) United States
(12) Patent Application Publication
(10) Pub. No.: US 2024/0385637 A1
(43) Pub. Date: Nov. 21, 2024

(54) BUFFER CIRCUIT FOR A LINEAR VOLTAGE REGULATOR

(71) Applicant: Texas Instruments Incorporated, Dallas, TX (US)

(72) Inventors: Varun Upadhyaya, NEW DELHI (IN); Venkateswarlu Ramaswamy T, Bangalore (IN)

(21) Appl. No.: 18/643,338

(22) Filed: Apr. 23, 2024

(30) Foreign Application Priority Data
May 15, 2023 (IN) 202341033874
May 15, 2023 (IN) 202341033875

(51) Int. Cl. G05F 1/575; G05F 1/595

(52) U.S. Cl. CPC G05F 1/575; G05F 1/595

(57) ABSTRACT

Described embodiments include a buffer circuit for a linear voltage regulator. A first transistor has first and second current terminals and a first control terminal. The first current terminal is coupled to an input voltage terminal. A second transistor is coupled between the input voltage terminal and an output voltage terminal, and has a second control terminal that is coupled to the first control terminal. A resistor is coupled between the second and fourth current terminals. A third transistor is coupled between the second current terminal and ground through a first current source. A fourth transistor is coupled between the fourth current terminal and ground through a second current source, and has a fourth control terminal coupled to the third control terminal and to the eighth current terminal.

### CROSS-REFERENCE TO RELATED APPLICATION

This application claims priority to India Patent Application No. 202341033874 filed May 15, 2023, and to India Patent Application No. 202341033875 filed May 15, 2023, both of which are incorporated herein by reference in their entirety.

### BACKGROUND

This description relates to buffers providing low quiescent current (I_{Q}) and low output impedance. The buffers described herein can be useful for linear voltage regulators, and particularly for low dropout voltage (LDO) linear voltage regulators having a requirement for good transient performance and low I_{Q}. This description further relates to stabilization of control loops within buffers that provide low I_{Q} and low output impedance, such as the control loops found in LDO linear voltage regulators.

LDO linear voltage regulators typically have a small input voltage to output voltage (V_{IN}-to-V_{OUT}) differential. In most cases, an LDO linear voltage regulator regulates a voltage by turning excess power into heat, making an LDO linear voltage regulator a suitable fit for low-power applications. LDO linear voltage regulators usually have requirements for a relatively fast transient response while also having a relatively high DC output voltage accuracy, low I_{Q}, and low output impedance.

In many cases, the circuitry implemented to help meet the requirement for a relatively fast transient response can work to the detriment of meeting the requirement for a relatively high DC output voltage accuracy and a low I_{Q}. To help meet the requirement for a relatively fast transient response while also having a relatively high DC voltage accuracy, two nested control loops may be used. However, variations in particular operating parameters can lead to loop stability problems.

### SUMMARY

In a first example, a buffer circuit for a linear voltage regulator includes a first transistor having first and second current terminals and a first control terminal. The first current terminal is coupled to an input voltage terminal. A second transistor has third and fourth current terminals and a second control terminal. The third current terminal is coupled to the input voltage terminal. The fourth current terminal is coupled to an output voltage terminal, and the second control terminal is coupled to the first control terminal. A resistor is coupled between the second current terminal and the fourth current terminal. A third transistor has fifth and sixth current terminals and a third control terminal. The fifth current terminal is coupled to the second current terminal.

A fourth transistor has seventh and eighth current terminals and a fourth control terminal. The seventh current terminal is coupled to the fourth current terminal, and the fourth control terminal is coupled to the third control terminal and to the eighth current terminal. A first current source is coupled between the sixth current terminal and a ground terminal. A second current source is coupled between the eighth current terminal and the ground terminal.

In a second example, a control circuit includes a current source having first and second current source terminals, wherein the first current source terminal is coupled to an input voltage terminal. A first transistor has first and second current terminals and a first control terminal. The first current terminal is coupled to the second current source terminal. A second transistor has third and fourth current terminals and a second control terminal. The third current terminal is coupled to the input voltage terminal, and the second control terminal is coupled to a feedback terminal.

A first resistor is coupled between an output voltage terminal and the feedback terminal. A second resistor is coupled between the feedback terminal and a ground terminal. A third transistor is coupled between the second current terminal and the ground terminal, and has a third control terminal. A fourth transistor is coupled between the fourth current terminal and the ground terminal, and has a fourth control terminal that is coupled to the third control terminal and to the fourth current terminal.

### BRIEF DESCRIPTION OF THE DRAWINGS

FIG. 1 shows a block diagram for an example low dropout voltage (LDO) linear voltage regulator integrated circuit system.

FIG. 2 shows a schematic diagram for an example super source follower (SSF) buffer circuit.

FIG. 3 shows a schematic diagram for an example buffer circuit with decreased quiescent current capable of operating in separate voltage domains.

FIG. 4 shows a schematic diagram for an example linear voltage regulator having a buffer circuit with decreased quiescent current capable of operating in separate voltage domains.

FIG. 5 shows an example Bode magnitude plot for a dual nested control loop circuit in a linear voltage regulator.

FIG. 6 shows a schematic diagram for an example output stage having a pseudo-ESR for increased stability.

FIG. 7 shows a schematic diagram for an example buffer circuit and output stage having a pseudo resistance implemented with high voltage FETs.

### DETAILED DESCRIPTION

In this description, the same reference numbers depict same or similar (by function and/or structure) features. The drawings are not necessarily drawn to scale.

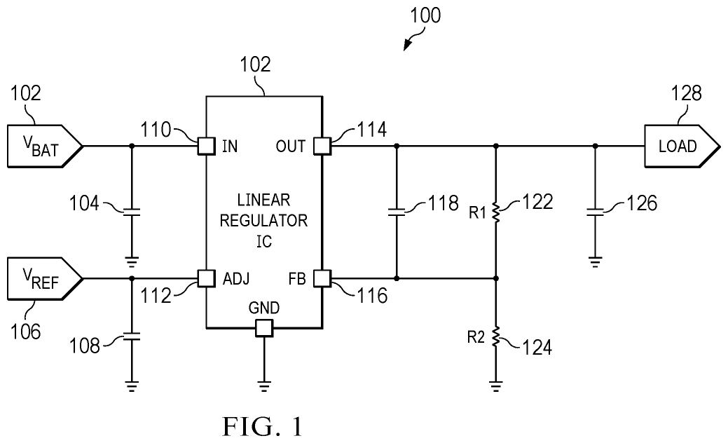

FIG. 1 shows a block diagram for an example low dropout voltage (LDO) linear voltage regulator integrated circuit (IC) system 100. LDO linear voltage regulator integrated circuit system 100 includes linear voltage regulator IC 120 which has five terminals. The terminals include input voltage terminal 110, output voltage terminal 114, adjustment terminal 112, feedback terminal 116, and a ground terminal.

Voltage source 102 is coupled to the input voltage terminal 110. In at least one example, voltage source 102 is a DC battery power source. Capacitor 104 is coupled between the input voltage terminal 110 and the ground terminal, and provides input voltage noise filtering. The adjustment terminal 112 is configured to be connected to a reference voltage source 106. Capacitor 108 is coupled between the adjustment terminal 112 and the ground terminal, and provides noise decoupling. Output voltage terminal 114 is coupled to a load 128. Capacitor 126 is coupled between the output voltage terminal 114 and the ground terminal.

Resistor R1 122 and resistor R2 124 are coupled in series between the output voltage terminal 114 and the ground terminal, and form a voltage divider on the output voltage. The connection terminal of the voltage divider is coupled to the feedback terminal and provides a feedback voltage for linear voltage regulator IC 120 to adjust the output voltage to within a specification. The ratio of the feedback voltage to the output voltage is determined by the respective resistance values of resistor R1 122 and resistor R2 124. Capacitor 118 is coupled between the output voltage terminal 114 and the feedback terminal 116.

Not all linear voltage regulators have an adjustment terminal 112. Instead, some linear voltage regulators may have an internal reference voltage for regulating the output voltage. The adjustment terminal 112 is more commonly used in high accuracy applications where a high accuracy external reference is required to generate an accurate output voltage.

Similarly, not all linear voltage regulators include a feedback terminal. However, some linear voltage regulators include a feedback terminal to provide added flexibility in being able to set the value of the output voltage by choosing the resistance values of resistor R1 122 and of resistor R2 124. To maintain high accuracy on output voltage in an LDO linear voltage regulator, linear voltage regulator IC 120 may include a slow control loop having a high gain error amplifier.

To achieve good transient performance in an LDO linear voltage regulator, linear voltage regulator IC 120 may include a fast control loop having a super source follower (SSF) circuit. In many cases, the slow control loop may be nested around the fast control loop. Having a low IQ can an important requirement for many LDO linear voltage regulators, which may limit the use of the nested dual-loop SSF circuit configuration in some cases.

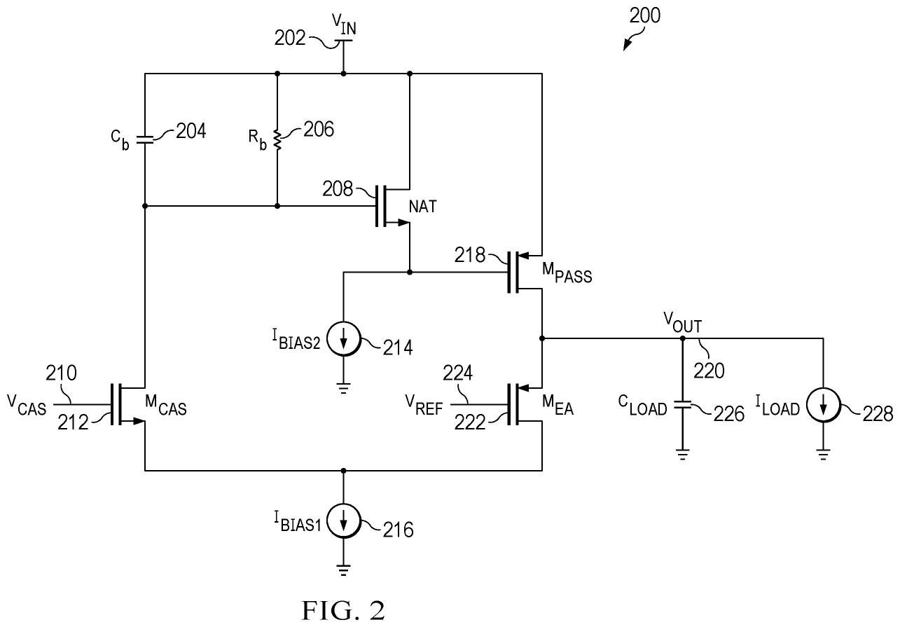

FIG. 2 shows a schematic diagram for an example SSF buffer circuit 200. An SSF buffer circuit can be useful in cases where a good transient performance is required. An input voltage terminal V_{IN} 202 is coupled to a drain of a FET 208. Resistor R_{b} 206 and capacitor C_{b} 204 are coupled in parallel between the drain and the source of FET 208. In at least one example, FET 208 is a native FET. However, in other examples, FET 208 could be another type of FET.

A current source I_{BIAS2} 214 is coupled between the source of FET 208 and a ground terminal. A FET M_{CAS} 212 has a drain coupled to the gate of FET 208, and a gate coupled to the output of an amplifier (not shown) that provides a voltage V_{CAS} 210. A current source I_{BIAS1} 216 is coupled between the source of FET M_{CAS} 212 and the ground terminal. FET M_{PASS} 218 is coupled between the input voltage terminal V_{IN} 202 and an output voltage terminal V_{OUT} 220, and has a gate coupled to the source of FET 208.

A FET M_{EA} 222 is coupled between the output voltage terminal V_{OUT} 220 and current source I_{BIAS1} 216, and has a gate coupled to a reference voltage terminal V_{REF} 224. Capacitor C_{LOAD} 226 is coupled between the output voltage terminal V_{OUT} 220 and the ground terminal. A load pulling a load current I_{LOAD} 228 is coupled between the output voltage terminal V_{OUT} 220 and the ground terminal.

SSF buffer circuit 200 uses a source follower, which typically has a low output impedance, inside of a negative feedback loop. The loop gains of the negative feedback loop reduce the output impedance further. The negative feedback loop begins at the output voltage terminal V_{OUT} 220, and flows through the FET M_{EA} 222. The current flowing through the FET M_{EA} 222 is folded through the FET M_{CAS} 212, and is provided to the gate of FET 208, creating a voltage at the gate of FET 208. The source of FET 208 is coupled to the gate of FET M_{PASS} 218. FET M_{CAS} 212 is a folded cascode. The FET M_{EA} 222 can be considered to be in series with FET M_{CAS} 212. Because its job is to fold back the current, FET M_{CAS} 212 is known as a folded cascode.

FET 208 is configured as a source follower and acts as a voltage buffer to drive the gate of the FET M_{PASS} 218. A signal inversion occurs in the FET M_{PASS} 218, making this feedback loop a negative feedback loop. The impedance at the output voltage terminal V_{OUT} 220 is 1/gm of the FET M_{EA} 222 divided by the loop gain of the negative feedback loop. Configured as a source follower looking at the output voltage terminal V_{OUT} 220, the loop responds quickly to any changes in the output voltage, making this configuration useful for linear voltage regulators.

However, there are two key limitations in SSF buffer circuit 200 that can make it impractical for use in linear voltage regulators that require external feedback terminals to program the output voltage. The first limitation is that the reference voltage provided at the reference voltage terminal V_{REF} 224 and the output voltage at the output voltage terminal V_{OUT} 220 must be in the same voltage domain to avoid damaging the FET M_{EA} 222. The gate to source voltage (V_{GS}) of the FET M_{EA} 222 cannot exceed the oxide rating of the FET, or the FET will become damaged.

Because FET M_{EA} 222 is configured as a voltage follower, the reference voltage provided at the reference voltage terminal V_{REF} 224 and the output voltage at the output voltage terminal V_{OUT} 220 must be held to within a threshold voltage of each other. Requiring that the reference voltage and output voltage be in the same voltage domain may be a significant limitation in some cases.

The second limitation is the current draw of current source I_{BIAS1} 216. For low I_{Q} circuits, I_{BIAS1} 216 typically needs to be relatively large to stabilize the loop and make the loop response fast enough. The magnitude of current source I_{BIAS1} 216 is determined by the resistance value of resistor R_{b} 206, which is usually chosen to help stabilize the control loop. A low resistance value for resistor R_{b} 206 is usually necessary due to stability constraints to limit the gain of the negative feedback loop and push the pole frequency out to a sufficiently high frequency.

Therefore, the current from current source I_{BIAS1} 216 needs to be relatively high to obtain the required voltage drop across resistor R_{b} 206. In some cases, the current from current source I_{BIAS1} 216 may consume 50-60% of the circuit's entire quiescent current specification. So, those are two key limitations in SSF buffer circuit 200 that can make it impractical for use in linear voltage regulators requiring external feedback terminals to program the output voltage.

In LDO linear voltage regulators, all the current is passed by the FET M_{PASS} 218. In order to pass the maximum load current I_{LOAD} 228, the FET M_{PASS} 218 may be sized to provide a relatively high current (e.g. 100 mA). For the FET M_{PASS} 218 to provide a relatively large amount of current, a relatively large V_{GS} (e.g. 3V) may be required on FET M_{PASS} 218.

The drain to source voltage (V_{DS}) of FET 208 is 3V in this case because the V_{GS} of FET M_{PASS} 218 is equal to the V_{DS} of FET 208. Because FET 208 is a native FET, the voltage between the gate and source is roughly 0V, so 3V is being dropped across R_{b} and C_{b}. To develop a 3V drop across R_{B}, a large current must flow through R_{B}, since its resistance is quite small (e.g. 1 Kohm). All of that current (e.g. 3 mA) is coming from I_{BIAS1} through FET M_{CAS} 212.

However, when not providing the maximum load current I_{LOAD} 228, some of the current provided by current source I_{BIAS1} 216 is wasted. When not providing the maximum load current I_{LOAD} 228, you don't need 3V V_{GS} for M_{PASS}. In this case, only 300 mV may be required instead of 3V for V_{GS}, but the DC current through I_{BIAS1} remains constant at a magnitude of 3 mA. In this case, the FET M_{CAS} 312 may only pass 1/10 of that current (i.e. 300 uA). The rest of the current flows through the FET M_{EA} 222. So, the configuration of SSF buffer circuit 200 may be undesirable from a quiescent current standpoint because 3 mA current is being provided by current source I_{BIAS1} 216 even when it is not required.

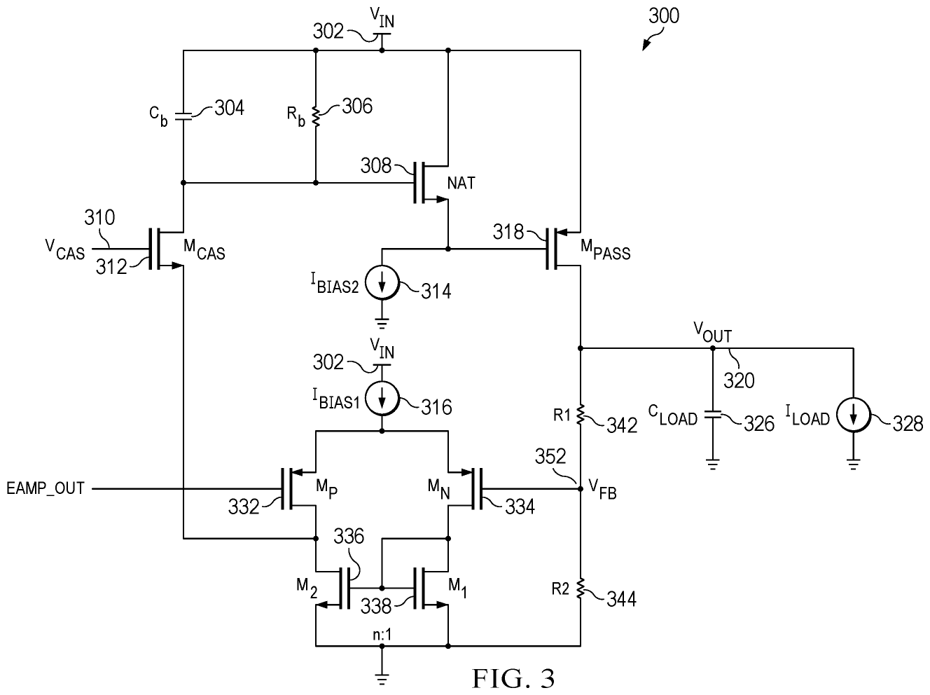

FIG. 3 shows a schematic diagram for an example buffer circuit 300 with decreased quiescent current capable of operating in separate voltage domains. An input voltage terminal V_{IN} 302 is coupled to a drain of a FET 308. Resistor R_{b} 306 and capacitor C_{b} 304 are coupled in parallel between the drain and the source of FET 308. In at least one example, FET 308 is a native FET. However, in other examples, FET 308 could be another type of FET.

A current source I_{BIAS2} 314 is coupled between the source of FET 308 and a ground terminal. A FET M_{CAS} 312 has a drain coupled to the gate of FET 308, and a gate coupled to the output of an amplifier (not shown) and receiving a voltage V_{CAS} 310. FET M_{PASS} 318 is coupled between the input voltage terminal V_{IN} 302 and an output voltage terminal V_{OUT} 320, and has a gate coupled to the source of FET 308. Capacitor C_{LOAD} 326 is coupled between the output voltage terminal V_{OUT} 320 and the ground terminal. A load pulling a load current I_{LOAD} 328 is coupled between the output voltage terminal V_{OUT} 320 and the ground terminal.

A current source I_{BIAS1} 316 has first and second terminals, and the first terminal is coupled to the input voltage terminal V_{IN} 302. A FET M_{P} 332 is coupled between the second terminal of current source I_{BIAS1} 316 and the source of FET M_{CAS} 312, and has a gate coupled to the output of an error amplifier (not shown) that provides a signal EAMP_OUT. A FET M₂ 336 is coupled between the drain of FET M_{P} 332 and the ground terminal.

A FET M_{N} 334 is coupled between the second terminal of current source I_{BIAS1} 316 and the gate of FET M₂ 336. A FET M₁ 338 has a drain coupled to the drain of FET M_{N} 334, a source coupled to the ground terminal, and a gate coupled to its drain and to the gate of FET M₂ 336. The ratio of the width of FET M₂ 336 to the width of FET M₁ 338 is n:1.

Resistor R1 342 and resistor R2 344 are coupled in series between the output voltage terminal V_{OUT} 320 and the ground terminal, and form a voltage divider. The center terminal of the voltage divider is coupled to the gate of FET M_{N} 334 and provides a feedback voltage V_{FB} 352 at the gate of FET M_{N} 334 for the regulation of the voltage at the output voltage terminal V_{OUT} 320. The ratio of the feedback voltage to the voltage at the output voltage terminal V_{OUT} 320 is set by the ratio of the resistance of resistor R2 344 to the sum of the resistances of resistor R1 342 and resistor R2 344.

In buffer circuit 300, the source follower of SSF buffer circuit 200 is replaced by a FET differential pair, FET M_{P} 332 and FET M_{N} 334. In at least one case, FET M_{P} 332 and FET M_{N} 334 are both p-channel FETs. Current source I_{BIAS1} 316, which was sinking current in the SSF buffer circuit 200, sources current to bias the FET M_{P} 332 and FET M_{N} 334 in buffer circuit 300.

Buffer circuit 300 has two voltage domains, a V_{OUT} voltage domain and a feedback voltage domain. As an example, in a case where the voltage at the output voltage terminal V_{OUT} 320 is 40V, the resistances of resistor R1 342 and resistor R2 344 could be chosen to provide a feedback voltage V_{FB} 352 of 2V. In this case, the V_{OUT} voltage domain and the feedback voltage domain would be separated from each other by 38V. This voltage difference is possible without damaging any of the devices because the V_{OUT} voltage domain and the feedback voltage domain are separated in buffer circuit 300. This also makes it feasible to have the same feedback mechanism for the negative feedback loop.

The signal at the output voltage terminal V_{OUT} 320 is divided down by the voltage divider created by resistor R1 342 and resistor R2 344, producing the feedback voltage V_{FB} 352. The feedback voltage V_{FB} 352 is provided to the differential pair made up of FET M_{N} 334 and FET M_{P} 332 at the gate of FET M_{N} 334. The differential pair made up of FET M_{N} 334 and FET M_{P} 332 generates a current proportional to VFB-EAMP_OUT that flows through FET M_{CAS} 312.

That current passes through resistor R_{b} 306 to FET 308, which is a voltage buffer, so it has a gain of one. An inversion of the signal polarity occurs from the gate to the drain of FET M_{PASS} 318, providing a negative feedback loop. The impedance Z_{OUT} at the output voltage terminal V_{OUT} 320 is given by equation 1:

$${Z}_{out} = \frac{1}{{gm}_{diff} * {R}_{b} * {gm}_{PASS}} * \frac{R 1 + R 2}{R 2} \qquad ( 1 )$$

where gm_{diff} is the transconductance of the differential pair made up of FET M_{N} 334 and FET M_{P} 332, R_{b} is the resistance of resistor R_{b} 306, R1 is the resistance of resistor R1 342, and R2 is the resistance of resistor R2 344.

Buffer circuit 300 provides a low output impedance and retains the benefit of having a good transient response from SSF buffer circuit 200, but also provides the additional advantage of separate voltage domains for the V_{OUT} voltage domain and the feedback voltage domain. The EAMP_OUT signal needs to be in the feedback voltage domain because it is being provided to the gate of FET M_{P} 332.

A second advantage that buffer circuit 300 provides is a reduction in the quiescent current. FET M₁ 338 and FET M₂ 336 form a current mirror that folds the current from the differential pair made up of FET M_{N} 334 and FET M_{P} 332 into the source of FET M_{CAS} 312. The differential pair is mirrored by FET M₁ 338 and FET M₂ 336 with an n:1 multiplier. The current from the current mirror biases the source of the FET M_{CAS} 312 rather than being biased entirely by I_{BIAS1}. This provides an effective way to multiply the I_{BIAS1} current by a factor of n.

So, when a higher load current is required and FET M_{PASS} 318 is biased at max strength, all of I_{BIAS1} flows through FET M_{N} 334, and the current at the output of the current mirror, which is the source of FET M_{CAS} 312, is n*I_{BIAS1}. That means that for the same drive strength, the current from I_{BIAS1} can be scaled down by a factor of n. The value of n is set by the ratio of the width of M₂ to the width of M₁.

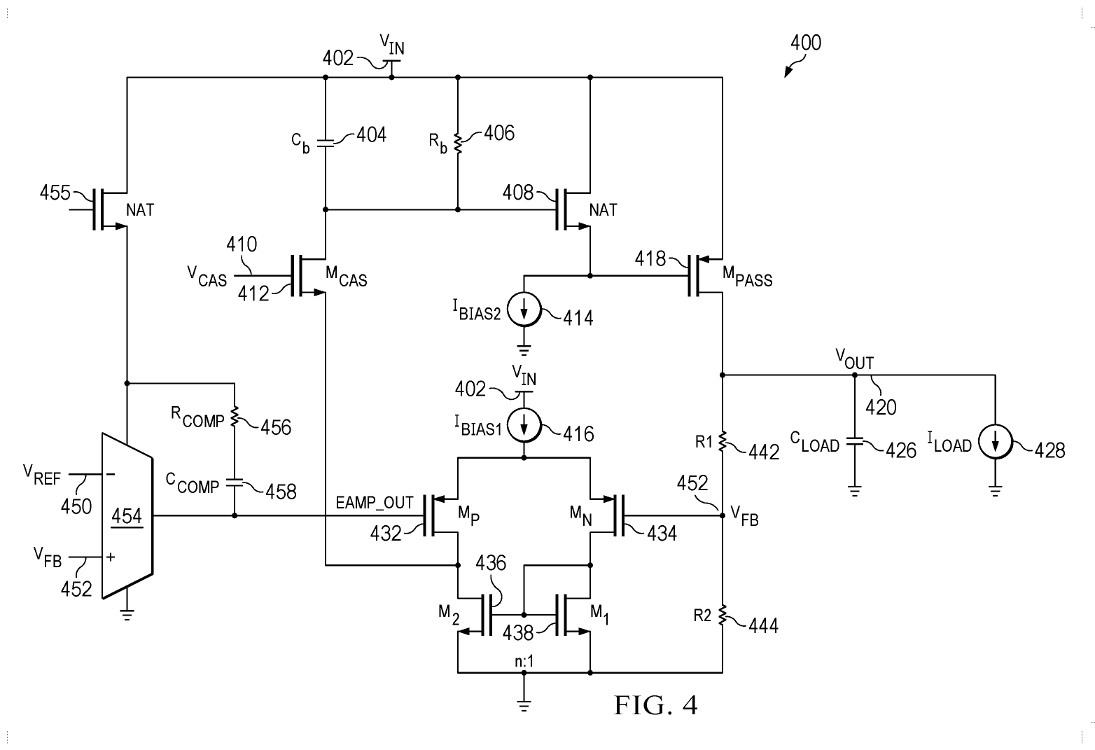

FIG. 4 shows a schematic diagram for an example linear voltage regulator 400 having a buffer circuit with decreased quiescent current capable of operating in separate voltage domains. An input voltage terminal V_{IN} 402 is coupled to a drain of a FET 408. Resistor R_{b} 406 and capacitor C_{b} 404 are coupled in parallel between the drain and the source of FET 408. In at least one example, FET 408 is a native FET. However, in other examples, FET 408 could be another type of FET.

A current source I_{BIAS2} 414 is coupled between the source of FET 408 and a ground terminal. A FET M_{CAS} 412 has a drain coupled to the gate of FET 408, and a gate coupled to the output of an amplifier (not shown) and receiving a voltage V_{CAS} 410. FET M_{PASS} 418 is coupled between the input voltage terminal V_{IN} 402 and an output voltage terminal V_{OUT} 420, and has a gate coupled to the source of FET 408. Capacitor C_{LOAD} 426 is coupled between the output voltage terminal V_{OUT} 420 and the ground terminal. A load pulling a load current I_{LOAD} 428 is coupled between the output voltage terminal V_{OUT} 420 and the ground terminal.

A current source I_{BIAS1} 416 has first and second terminals, and the first terminal is coupled to the input voltage terminal V_{IN} 402. A FET M_{P} 432 is coupled between the second terminal of current source I_{BIAS1} 416 and the source of FET M_{CAS} 412, and has a gate. Error amplifier 454 has a first input coupled to a voltage reference source V_{REF} 450, and a second input coupled to a feedback voltage terminal that provides a feedback voltage V_{FB} 452. A FET 455 is coupled between the input voltage terminal V_{IN} 402 and a supply terminal for error amplifier 454. Resistor R_{COMP} 456 and capacitor C_{COMP} 458 are coupled in series between the supply terminal of error amplifier 454 and the output of error amplifier 454.

A FET M₂ 436 is coupled between the drain of FET M_{P} 432 and the ground terminal. A FET M_{N} 434 is coupled between the second terminal of current source I_{BIAS1} 416 and the gate of FET M₂ 436. A FET M₁ 438 has a drain coupled to the drain of FET M_{N} 434, a source coupled to the ground terminal, and a gate coupled to its drain and to the gate of FET M₂ 436. The ratio of the width of FET M₂ 436 to the width of FET M₁ 438 is n:1.

Resistor R1 442 and resistor R2 444 are coupled in series between the output voltage terminal V_{OUT} 420 and the ground terminal, and form a voltage divider. The center terminal of the voltage divider is coupled to the gate of FET M_{N} 434 and provides a feedback voltage V_{FB} 452 for the regulation of the voltage at the output voltage terminal V_{OUT} 420 and is coupled to the gate of FET M_{N} 434. The ratio of the feedback voltage to the voltage at the output voltage terminal V_{OUT} 420 is set by the ratio of the resistance of resistor R2 444 to the sum of the resistances of resistor R1 442 and resistor R2 444. FET M₁ 438 and FET M₂ 436 form a ratioed current mirror that allows scaling back the current provided by current source IBIAS1 416 by a factor of n, thus reducing the I_{Q}.

Linear voltage regulator 400 is controlled and stabilized by two control loops, an inner loop and an outer loop. The inner loop is a buffer loop that provides a relatively low output impedance looking in to the circuit from the output voltage terminal V_{OUT} 420. The buffer loop helps linear voltage regulator 400 to provide a good transient response. The outer loop is a voltage loop that helps to provide a relatively high accuracy on the DC output voltage. The voltage loop is a slow loop that has a high DC loop gain and a lower bandwidth. The buffer loop is a fast loop that has a high bandwidth to help provide a good transient response, but does not have a DC loop gain.

Dual nested control loops are used to help provide a good transient response while also having a high DC output voltage accuracy. Having one of the control loops be substantially slower than the other control loop can help to provide stability to the circuit. In the case of linear voltage regulator 400, the fast loop is the buffer loop that helps to provide a good transient response, and the slow loop is the voltage loop that helps to provide a high accuracy in the DC output voltage. In at least some cases, the faster buffer loop is required to have a bandwidth approximately five times the bandwidth of the slower voltage loop.

Stabilizing the faster buffer loop can have certain challenges. One challenge is a result of having a wide range of equivalent series resistance (ESR), such as due to the ESR of the load capacitor (e.g. C_{LOAD}) 426), which can range from a few milliohms to tens of ohms. The ESR can create a left-half-plane zero in the frequency response of the faster buffer loop. Stabilizing the faster buffer loop both with that zero and without that left-half-plane zero can become a challenging problem. In some cases, a reverse current protection FET may be coupled in series with the pass FET (e.g. M_{PASS} 418) that injects a right half plane zero that can add to the challenge of stabilizing the faster loop.

Complex poles can be formed in conditions where a higher load current is combined with a lower output capacitance due to the nested loop circuit configuration. The bandwidth of the slower loop (i.e. buffer loop) begins to increase. If the bandwidth becomes high enough, the multiple of five separation in frequency between the slower loop and the faster loop can be violated. If that occurs, complex poles may form in the slower loop.

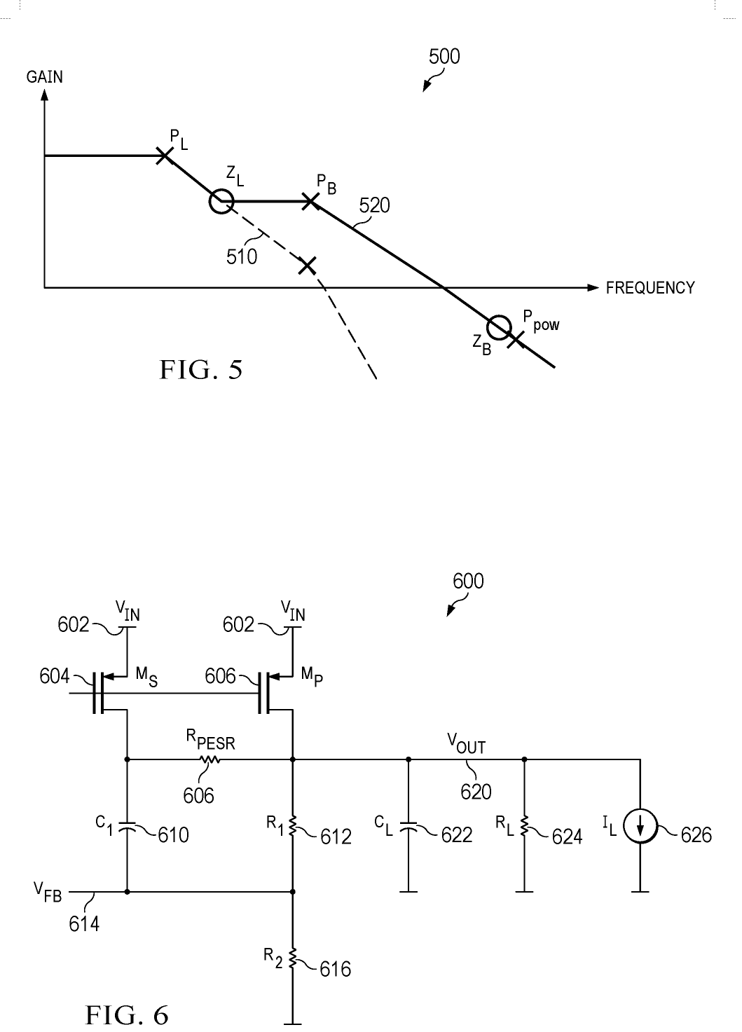

A right half plane zero decreases the phase margin and increases the bandwidth of the control loop, potentially making it uncontrollably high. So, from the standpoint of loop stability, a right half plane zero is worse than a pole. FIG. 5 shows an example Bode magnitude plot 500 for a dual nested control loop circuit in a linear voltage regulator. Curve 510 shows a magnitude response for a circuit having a near-zero ESR in the output stage. Curve 520 shows a magnitude response for a circuit having a sufficiently high ESR in the output stage.

In cases where the output capacitor has a sufficiently high ESR, a zero Z_{L}, is added to the response which flattens out the magnitude response and increases the phase margin as shown in the curve 520. But in other cases, where a low-capacitance high-quality capacitor having a near-zero ESR is used, the faster loop will have a response as shown in curve 510. Curve 510 shows a response having two consecutive poles. Curve 520 shows a response having a pole followed by a zero, followed by a second pole. The response of curve 520 results in high phase margin and high bandwidth. The response of curve 510 results in low phase margin and low bandwidth, and is undesirable.

One potential solution to the stability problem of curve 510 is to add an intentional resistor in series with the output capacitor to intentionally create a resistance to provide a zero in the response even in cases where the output capacitor does not have an appreciable ESR. Having a minimum resistance will in most cases limit the maximum frequency of the zero Z_{L}. In cases where the output capacitor has a higher ESR, adding the additional resistance adds to the value of the zero, moving the zero lower in frequency. Having this resistance in series with the output capacitor can help to change the response from that of curve 510 to the response of curve 520, thus increasing the bandwidth and phase margin.

FIG. 6 shows a schematic diagram for an example output stage 600 having a pseudo-ESR for increased stability. FET M_{S} 604 is coupled between an input voltage terminal V_{IN} 602 and a feedback voltage terminal V_{FB} 614 through capacitor C₁ 610. FET M_{P} 606 is coupled between the input voltage terminal V_{IN} 602 and an output voltage terminal V_{OUT} 620. The gate of FET M_{P} 606 is coupled to the gate of FET M_{S} 604. Resistor R₁ 612 and resistor R₂ 616 are coupled between the output voltage terminal V_{OUT} 620 and a ground terminal, and form a voltage divider. The feedback voltage terminal V_{FB} 614 is coupled to the center terminal of the voltage divider.

Capacitor C_{L} 622 is coupled between the output voltage terminal V_{OUT} 620 and the ground terminal. Resistor RL 624 is coupled between the output voltage terminal V_{OUT} 620 and the ground terminal. A load drawing a load current I_{L} 626 is coupled between the output voltage terminal V_{OUT} 620 and the ground terminal.

The load current I_{L} 626 flows through FET M_{P} 606 and is mirrored into FET M_{S} 604. In at least one case, the area of FET M_{S} 604 is between 100 and 1000 times smaller than the area of FET M_{P} 606. So, FET M_{S} 604 carries a mirrored but much lower amplitude version of the current flowing through FET M_{P} 606. That mirrored current flows through the terminal connecting high-voltage capacitor C₁ 610 and resistor R_{PESR} 608 and creates the effect of having a voltage drop across resistor R_{PESR} 608 without actually having it in the main current-carrying path.

This is a pseudo ESR technique in which a current is mirrored at a ratio of as much as 1:1000, and flows through a resistance that is scaled up by the same ratio (i.e. 1000). So, if 0.5 ohms would otherwise be inserted in series with the output capacitor to simulate an ESR, a resistance of 500 ohms is instead used for resistor R_{PESR} 608. High-voltage capacitor C₁ 610 couples the voltage movement between the drain of FET M_{S} 604 and the drain of FET M_{P} 606 onto the voltage divider, which is then provided to the feedback voltage terminal V_{FB} 614.

This is known as a pseudo ESR because there is no actual resistor in the output current path, but instead the effect of that resistor is mimicked through high voltage capacitor C₁ 610. Capacitor C₁ 610 injects the AC voltage ripple from the resistor R_{PESR} 608 into the feedback path. The pole that capacitor C₁ 610 makes with the resistance of resistor R₁ 612 in parallel with resistor R₂ 616 is much lower in frequency than the pseudo ESR zero. The value of resistance for resistor R_{PESR} 608 can be calculated using equation 2:

$${R}_{PESR} = \frac{( {W}_{P} / {L}_{P} )}{( {W}_{S} / {L}_{S} )} {R}_{ESR} \qquad ( 2 )$$

where W_{P} is the width of FET M_{P} 606, L_{P} is the length of FET M_{P} 606, W_{S} is the width of FET M_{S} 604, and L_{S} is the length of FET M_{S} 604.

However, a drawback to the configuration of output stage 600 is that capacitor C₁ 610 is required to be a high voltage capacitor. Capacitor C₁ 610 is required to be a high voltage capacitor because the output voltage terminal V_{OUT} 620 and the feedback voltage terminal V_{FB} 614 may be in different voltage domains. For example, the voltage at the output voltage terminal V_{OUT} 620 may be 40V, and the voltage at the feedback voltage terminal V_{FB} 614 may be 2V. In this case, the capacitor C₁ 610 would then be required to sustain 38V across it. That voltage across capacitor C₁ 610 requires the capacitor to be quite large in size. High voltage capacitors usually have a low density and are typically not area efficient, making the capacitor significantly large in area.

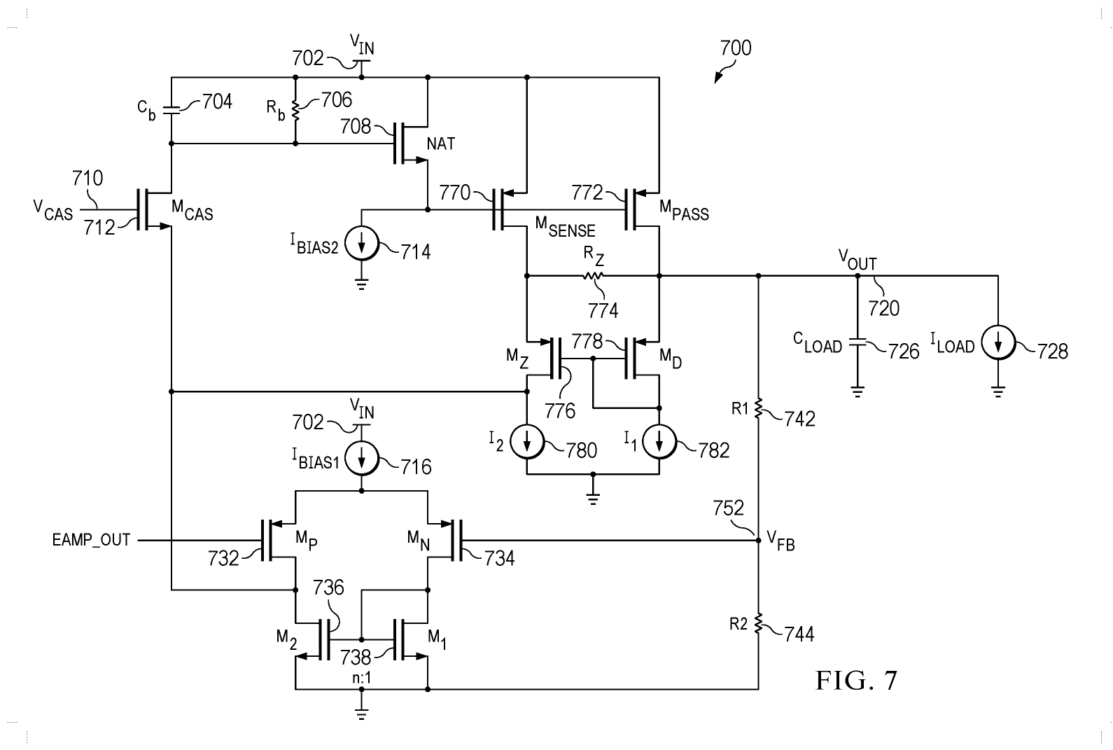

Although using a high voltage capacitor may be impractical in some cases because of the large area they take up, high voltage FETs are available and more area-efficient, and do not have the same drawbacks seen with high voltage capacitors. So, a potential solution is to replace the high voltage capacitor with high voltage FETs. FIG. 7 shows a schematic diagram for an example buffer circuit and output stage 700 having a pseudo resistance implemented with high voltage FETs.

An input voltage terminal V_{IN} 702 is coupled to the drain of FET 708. Resistor R_{b} 706 and capacitor C_{b} 704 are coupled in parallel between the drain and the source of FET 708. In at least one example, FET 708 is a native FET. However, in other examples, FET 708 could be another type of FET.

A current source I_{BIAS2} 714 is coupled between the source of FET 708 and a ground terminal. A FET M_{CAS} 712 has a drain coupled to the gate of FET 708, and a gate coupled to the output of an amplifier (not shown) and receiving a voltage V_{CAS} 710. FET M_{PASS} 772 is coupled between the input voltage terminal V_{IN} 702 and an output voltage terminal V_{OUT} 720, and has a gate coupled to the source of FET 708. Capacitor C_{LOAD} 726 is coupled between the output voltage terminal V_{OUT} 720 and the ground terminal. A load pulling a load current I_{LOAD} 728 is coupled between the output voltage terminal V_{OUT} 720 and the ground terminal.

A FET M_{SENSE} 770 has a source coupled to the input voltage terminal V_{IN} 702, and has a gate coupled to the source of FET 708. FET M_{PASS} 772 is coupled between the input voltage terminal V_{IN} 702 and an output voltage terminal V_{OUT} 720, and has a gate coupled to the source of FET 708 and the gate of FET M_{SENSE} 770. Resistor R_{Z} 774 is coupled between the drain of FET M_{SENSE} 770 and the drain of FET M_{PASS} 772.

FET M_{Z} 776 is coupled between the drain of FET M_{SENSE} 770 and the source of FET M_{CAS} 712. FET M_{D} 778 is coupled between the drain of FET M_{PASS} 772 and the gate of FET M_{Z} 776, and has a gate coupled to the gate of FET M_{Z} 776. Current source I2 780 is coupled between the drain of FET M_{Z} 776 and the ground terminal. Current source I1 782 is coupled between the drain of FET M_{D} 778 and the ground terminal.

A current source I_{BIAS1} 716 has first and second terminals, and the first terminal is coupled to the input voltage terminal V_{IN} 702. A FET M_{P} 732 is coupled between the second terminal of current source I_{BIAS1} 716 and the source of FET M_{CAS} 712, and has a gate coupled to the output of an error amplifier (not shown) that receives a signal EAMP_OUT. A FET M_{N} 734 is coupled between the second terminal of current source I_{BIAS1} 716 and the gate of FET M₂ 736. A FET M₁ 738 has a drain coupled to the drain of FET M_{N} 734, a source coupled to the ground terminal, and a gate coupled to its drain and to the gate of FET M₂ 736. The ratio of the width of FET M₂ 736 to the width of FET M₁ 738 is n:1.

Resistor R1 742 and resistor R2 744 are coupled in series between the output voltage terminal V_{OUT} 720 and the ground terminal, and form a voltage divider. The center terminal of the voltage divider is coupled to the gate of FET M_{N} 734 and provides a feedback voltage V_{FB} 714 at the gate of FET M_{N} 734 for the regulation of the voltage at the output voltage terminal V_{OUT} 720. The ratio of the feedback voltage to the voltage at the output voltage terminal V_{OUT} 720 is set by the ratio of the resistance of resistor R2 744 to the sum of the resistances of resistor R1 742 and resistor R2 744.

The load current I_{LOAD} 728 flows through FET M_{PASS} 772 and is mirrored into FET M_{SENSE} 770. In at least one case, the area of FET M_{SENSE} 770 is between 100 and 1000 times smaller than the area of FET M_{PASS} 772. So, FET M_{SENSE} 770 carries a mirrored but much lower amplitude version of the current flowing through FET M_{PASS} 772. That mirrored current flows through resistor R_{Z} 774 and creates the effect of having a voltage drop without the voltage drop occurring in the main current-carrying path.

An AC voltage ripple is injected through resistor R_{Z} 774 into a differential pair of FETs, FET M_{Z} 776 and FET M_{D} 778. The AC voltage ripple provides a voltage difference on the source of FET M_{Z} 776, which injects a current proportional to the gm of FET M_{Z} 776 into the source of FET M_{CAS} 712. FET M_{Z} 776 and FET M_{D} 778 are each high voltage FETs. The voltage drop is primarily across FET M_{Z} 776, and the voltage drop could be as high as 40V. The FET differential pair effectively mimics a high voltage capacitor and achieves the same result, which is to generate a pseudo ESR resistance.

The ESR is a function of the widths of FET M_{PASS} 772 and FET M_{SENSE}, 770, as well as the Gₘ ratio of the two FET differential pairs. The Gm ratio can be calculated using equation 3:

$${Gm}_{ratio} = \frac{{G}_{mz} * ( {G}_{mp} + {G}_{mn} )}{( n + 1 ) * {G}_{mp} * {G}_{mn}} \qquad ( 3 )$$

where G_{mz} is the gₘ of FET M_{Z} 776, Gₘₚ is the gₘ of FET M_{P} 732, and Gₘₙ is the gₘ of FET M_{N} 734. The effective ESR R_{ESR} can be calculated using equation 4:

$${R}_{ESR} = \frac{{G}_{mSENSE}}{{G}_{mPASS}} * {R}_{Z} * {Gm}_{ratio} \qquad ( 4 )$$

where G_{mSENSE} is the gₘ of FET M_{SENSE} 770, G_{mPASS} is the gₘ of FET M_{PASS} 772, and R_{Z} is the resistance value of resistor R_{Z} 774.

The gate of FET M_{Z} is biased with respect to the voltage at the output voltage terminal V_{OUT} 720 to ensure that only the AC portion of the signal is passed. The buffer circuit and output stage 700 can generate a pseudo ESR zero in the fast loop (i.e. buffer loop) of an LDO linear voltage regulator without using a high voltage capacitor. A high voltage capacitor is replaced with a high voltage FET that injects current into a differential pair signal path to create the effect of an ESR zero. The high voltage FET is much lower cost than the high voltage capacitor. In one example, the silicon area for the high voltage capacitor was 10 times the area of the high voltage FET. So, replacing the high voltage capacitor with a high voltage FET provides significant cost savings.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A buffer circuit for a linear voltage regulator, comprising:
a first transistor having first and second current terminals and a first control terminal, wherein the first current terminal is coupled to an input voltage terminal;
a second transistor having third and fourth current terminals and a second control terminal, wherein the third current terminal is coupled to the input voltage terminal, the fourth current terminal is coupled to an output voltage terminal, and the second control terminal is coupled to the first control terminal;
a resistor coupled between the second current terminal and the fourth current terminal;
a third transistor having fifth and sixth current terminals and a third control terminal, wherein the fifth current terminal is coupled to the second current terminal;
a fourth transistor having seventh and eighth current terminals and a fourth control terminal, wherein the seventh current terminal is coupled to the fourth current terminal, and the fourth control terminal is coupled to the third control terminal and to the eighth current terminal;
a first current source coupled between the sixth current terminal and a ground terminal; and
a second current source coupled between the eighth current terminal and the ground terminal.

2. The buffer circuit of claim 1, further comprising:
a fifth transistor having ninth and tenth current terminals and a fifth control terminal, wherein the tenth current terminal is coupled to the sixth current terminal;
a sixth transistor having eleventh and twelfth current terminals and a sixth control terminal, wherein the eleventh current terminal is coupled to the input voltage terminal, the twelfth current terminal is coupled to the first control terminal, and the sixth control terminal is coupled to the ninth current terminal; and
a third current source coupled between the twelfth current terminal and the ground terminal.

3. The buffer circuit of claim 1, further comprising:
a fourth current source having first and second current source terminals, wherein the first current source terminal is coupled to the input voltage terminal;
a seventh transistor having thirteenth and fourteenth current terminals and a seventh control terminal, wherein the thirteenth current terminal is coupled to the second current source terminal, and the fourteenth current terminal is coupled to the sixth current terminal;
an eighth transistor having fifteenth and sixteenth current terminals and an eighth control terminal, wherein the fifteenth current terminal is coupled to the second current source terminal, and the eighth control terminal is coupled to a feedback terminal;
a ninth transistor coupled between the fourteenth current terminal and the ground terminal, and having a ninth control terminal coupled to the sixteenth current terminal; and
a tenth transistor coupled between the sixteenth current terminal and the ground terminal, and having a tenth control terminal coupled to the ninth control terminal and to the sixteenth current terminal.

4. The buffer circuit of claim 2, wherein the resistor is a first resistor, and the buffer circuit is further comprising a second resistor and a capacitor coupled in parallel between the input voltage terminal and the sixth control terminal.

5. The buffer circuit of claim 3, wherein an output voltage at the output voltage terminal is in a first voltage domain, and a feedback voltage at the feedback terminal is in a second voltage domain.

6. The buffer circuit of claim 5, wherein the first voltage domain is a higher voltage domain, and the second voltage domain is a lower voltage domain.

7. The buffer circuit of claim 3, wherein the resistor is a first resistor, and the buffer circuit is further comprising:
a second resistor coupled between the output voltage terminal and the feedback terminal; and
a third resistor coupled between the feedback terminal and the ground terminal.

8. The buffer circuit of claim 2, wherein the sixth transistor is a native field effect transistor (FET).

9. The buffer circuit of claim 3, wherein the ninth transistor and the tenth transistor are each field effect transistors (FETs) having different areas, and a ratio of an area of the ninth transistor to an area of the tenth transistor is N:1.

10. The buffer circuit of claim 9, wherein the ninth transistor and the tenth transistor form a current mirror, and a current through the ninth transistor equals a current through the tenth transistor with an attenuation factor of N.

11. The buffer circuit of claim 1, wherein the first transistor and the second transistor are each FETs having different areas, and a ratio of an area of the second transistor to an area of the first transistor is M:1.

12. The buffer circuit of claim 11, wherein M is equal to or greater than 100.

13. The buffer circuit of claim 1, wherein the first transistor and the second transistor are each high voltage FETs.

14. A control circuit, comprising:
a current source having first and second current source terminals, wherein the first current source terminal is coupled to an input voltage terminal;
a first transistor having first and second current terminals and a first control terminal, wherein the first current terminal is coupled to the second current source terminal;
a second transistor having third and fourth current terminals and a second control terminal, wherein the third current terminal is coupled to the input voltage terminal, and the second control terminal is coupled to a feedback terminal;
a first resistor coupled between an output voltage terminal and the feedback terminal;
a second resistor coupled between the feedback terminal and a ground terminal;
a third transistor coupled between the second current terminal and the ground terminal, and having a third control terminal; and
a fourth transistor coupled between the fourth current terminal and the ground terminal, and having a fourth control terminal coupled to the third control terminal and to the fourth current terminal.

15. The control circuit of claim 14, wherein the current source is a first current source, and the control circuit is further comprising:
a fifth transistor having fifth and sixth current terminals and a fifth control terminal, wherein the sixth current terminal is coupled to the second current terminal;
a sixth transistor having seventh and eighth current terminals and a sixth control terminal, wherein the seventh current terminal is coupled to the input voltage terminal, and the sixth control terminal is coupled to the fifth current terminal;
a second current source coupled between the eighth current terminal and the ground terminal; and
a seventh transistor coupled between the input voltage terminal and the output voltage terminal, and having a seventh control terminal coupled to the eighth current terminal.

16. The control circuit of claim 15, further comprising a resistor and a capacitor coupled in parallel between the input voltage terminal and the sixth control terminal.

17. The control circuit of claim 15, wherein an output voltage at the output voltage terminal is in a first voltage domain, and a feedback voltage at the feedback terminal is in a second voltage domain.

18. The control circuit of claim 17, wherein the first voltage domain is a higher voltage domain, and the second voltage domain is a lower voltage domain.

19. The control circuit of claim 15, wherein the sixth transistor is a native field effect transistor (FET).

20. The control circuit of claim 19, wherein the third transistor and the fourth transistor are each field effect transistors (FETs) having different areas, and a ratio of an area of the third transistor to an area of the fourth transistor is N:1.

21. The control circuit of claim 20, wherein the third transistor and the fourth transistor form a current mirror, and a current through the third transistor equals a current through the fourth transistor with an attenuation factor of N.
